(19) United States
(12) Patent Application Publication
(10) Pub. No.: US 2026/0081986 A1
(43) Pub. Date: Mar. 19, 2026

(54) IDENTIFICATION AND PRESENTATION OF PHONE NUMBERS WITH GEOGRAPHICAL CONTEXT

(71) Applicant: Twilio Inc., San Francisco, CA (US)

(72) Inventors: Danijel Šumberac, Kildare (IE); Micah James Phelps, Vancouver,, WA (US)

(21) Appl. No.: 18/889,897

(22) Filed: Sep. 19, 2024

(51) Int. Cl. H04M 1/724; H04W 4/02

(52) U.S. Cl. CPC H04M 1/724; H04W 4/02

(57) ABSTRACT

A graphical user interface (GUI) comprising a geographical map is provided. A first user input indicating a latitude value and a longitude value of a geographical region on the geographical map and a second user input indicating a radius value of the geographical region are received via the GUI. One or more queries for phone numbers of a phone number datastore are generated using the latitude value, the longitude value, and the radius value of the geographical region. One or more sets of phone number search results associated with the geographical region are received. Each set of the one or more sets of phone number search results corresponds to a respective query of the one or more queries. The one or more sets of phone number search results are presented via the GUI using one or more phone number GUI elements overlaid on the geographical map.

### TECHNICAL FIELD

Aspects and embodiments of the present disclosure relate to phone number datastores, and in particular to identification and presentation of phone numbers with geographical context.

### BACKGROUND

Phone numbers can be associated with prefixes corresponding to geographical regions. For example, a phone number can have a country code corresponding to a country and a prefix (e.g., an area code) corresponding to a locality or local region. Phone numbers can support various capabilities, such as voice, Short Message Service (SMS) messages, Multimedia Messaging Service (MMS), or similar.

### BRIEF DESCRIPTION OF DRAWINGS

Various embodiments in accordance with the present disclosure will be described with reference to the drawings, in which:

FIG. 1 is a block diagram of an example system architecture for identification and presentation of phone numbers in a database using a geographical map, in accordance with an embodiment;

FIG. 2 illustrates an example geographical map of a GUI provided to a client device by a geographical map service, in accordance with an embodiment;

FIGS. 3A-B illustrate example geographical maps of a GUI with geographical search regions divided into multiple subregions, in accordance with an embodiment;

FIG. 4A illustrates an example geographical map of a GUI with phone number search results presented on the geographical map, in accordance with an embodiment;

FIG. 4B illustrates example geographical map of a GUI with phone number metadata presented on the geographical map, in accordance with an embodiment;

FIG. 5 is a flow diagram of an example method for identification and presentation of phone numbers with geographical context, in accordance with an embodiment; and

FIG. 6 illustrates an example computer system, in accordance with an embodiment.

### DETAILED DESCRIPTION

Aspects of the present disclosure relate to identification and presentation of phone numbers in a database using a geographical map. Telecommunications providers can possess numerous phone numbers in many geographical regions. For example, telecommunications providers can own numbers in multiple countries and/or localities. These numbers can be used for various purposes. For example, numbers can be used to send or receive automated text and voice messages from a relevant geographical region (e.g., regions local to the senders or recipients of these messages). Telecommunications providers can resell these numbers to customers (e.g., end-users, other software providers), make these numbers available to customers for use as a service, or use these numbers for their own purposes and with their own services. For example, a telecommunications provider can make these numbers available to customers in association with cloud-based communication services provided to the customers (e.g., via web service APIs). Telecommunications providers can store data and metadata associated with these numbers in internal databases and can make this data available for searching by users (e.g., customers or employees of a provider).

The above-described systems and users of those systems (e.g., telecommunications providers, customers, end-users, etc.) can face several challenges related to identifying, presenting, and understanding database phone numbers in a geographic context. Among these challenges are: (i) determining effective phone number search queries for a specific geographic region, and (ii) conveying geographical context for phone number search results.

First, users may be unable to determine effective search queries to obtain numbers associated with a specific geographic region, such as a country or locality. For example, some phone number databases can allow users to search by a specific country code or prefix (e.g., a 3-digit area code or other prefix have various numbers of digits), but users may not know the country code or prefix for the desired geographical search region ahead of time. Similarly, some phone number databases can allow users to search by a city or country name, but these searches may fail to return results in neighboring localities that may also be of interest to the user (e.g., neighboring cities may have the same prefix as the searched city, and thus may be relevant to the user's query).

Second, systems may be unable to present search results in a manner that effectively conveys the geographical context of the search results to users. For example, some phone number databases can return a list or table of phone number search results with metadata such as country code, prefix, city, phone number functionality (e.g., calls, SMS, etc.). Users can find it difficult to parse the whole list/table and develop an intuitive understanding of the geographical context of the search results.

As a result of these challenges, telecommunications providers and their users can experience inefficiencies in the phone number search and discovery process. Telecommunications providers can find that some of their phone numbers are difficult for users to discover, and users may have to conduct multiple searches to find relevant phone numbers. This can lead to inefficient use of telecommunication providers'phone number resources and increased resource consumption (e.g., power, compute capacity) during these inefficient search processes.

Aspects of the present disclosure address the above challenges and other challenges by providing techniques for using geographical context to search a phone number datastore and present relevant results. An example system can include one or more of the following components: (i) a geographical map interface enabling searching phone numbers based on a selected location and radius, and (ii) a geographical map interface for presenting phone number search results at relevant locations. These components are further described below.

In an embodiment, a phone number datastore system's search interface includes a graphical user interface (GUI) that presents a geographical map to a user. The user can select a location on the map (e.g., correspond to a latitude and longitude) and a search radius centered on that location. The system can generate one or more search queries based on the selected location and radius. For example, the system can convert the location and radius into relevant country/prefixes or other search parameters using, e.g., a mapping or secondary datastore. The system can generate multiple queries corresponding to subregions within the selected location and radius.

In an embodiment, a phone number datastore system presents search results to a user using a GUI that includes a geographical map. The system can determine a relevant geographical location (e.g., latitude and longitude) for a phone number based on metadata associated with the phone number, such as country/prefix. The system can display an interactive indicator for the phone number on the geographical map. Upon user interaction with the interactive indicator, the system can present detailed metadata associated with the phone number.

Accordingly, telecommunications providers and their users using these techniques can experience improved efficiency in the phone number search and discovery process. Telecommunications providers can achieve more effective discovery and use of their available phone numbers, and users can find relevant phone numbers with fewer and more intuitive searches. This can lead to efficient use of telecommunication providers'phone number resources and decreased resource consumption during the search process. For example, these techniques can reduce the number of database queries and associated resource consumption (e.g., compute capacity, power, etc.) needed for a user to find relevant phone numbers. Furthermore, user interface elements associated with these techniques (e.g., navigable geographical maps) can enhance these advantages by providing more intuitive interfaces to phone number databases that make more efficient use of available GUI resources (e.g., screen real estate) and require less user interaction than, e.g., navigating multiple graphical menus or tables of phone numbers.

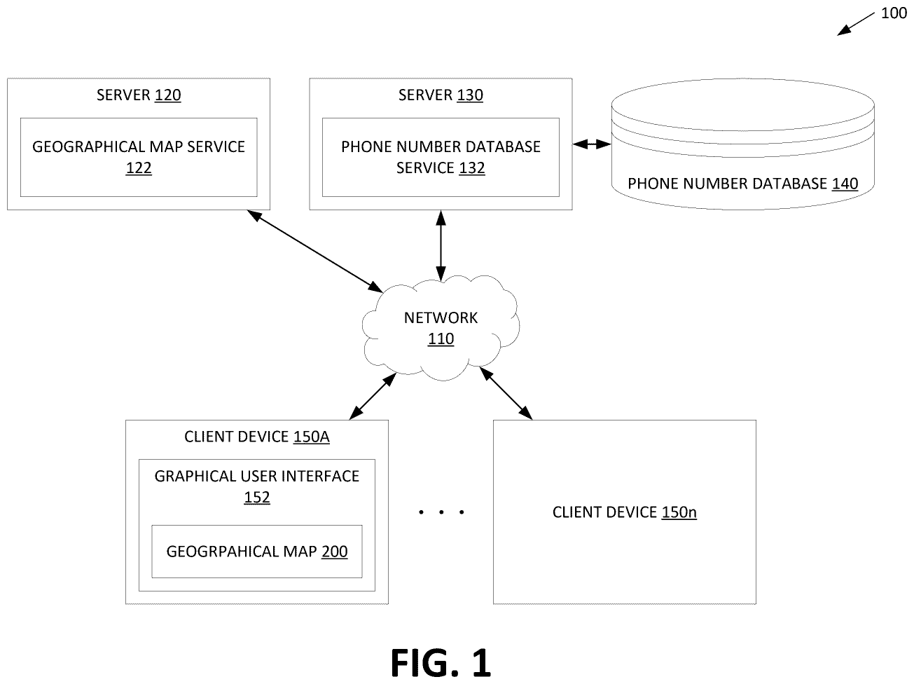

FIG. 1 is a block diagram of an example system architecture 100 for identification and presentation of phone numbers in a database using a geographical map, in accordance with an embodiment. System architecture 100 (also referred to as “system” herein) includes network 110, servers 120-130, phone number database 140, and client devices 150A-n. In various embodiments, system 100 can include more or fewer components in different configurations than those depicted in FIG. 1. For example, system 100 can include additional servers in an embodiment.

Network 110 can include a public network (e.g., the Internet), a private network (e.g., a LAN, a WAN, a VPN, an enterprise network), a wired network (e.g., Ethernet), a wireless network (e.g., an 802.11 Wi-Fi network), a cellular network (e.g., a 5G network), routers, hubs, switches, server computers, or a combination thereof. Network 110 or components thereof can be associated with different organizations in various embodiments. For example, components of network 110 can be associated with Internet Service Providers (ISPs), mobile or cellular carriers, cloud platform or software-as-a-service (SaaS) providers, private or public enterprises, private households or communities, etc. In an embodiment, network 110 (or a component thereof) can be a physical or virtual interconnect within a single device, such as a PCIe bus, a messaging system, or an API.

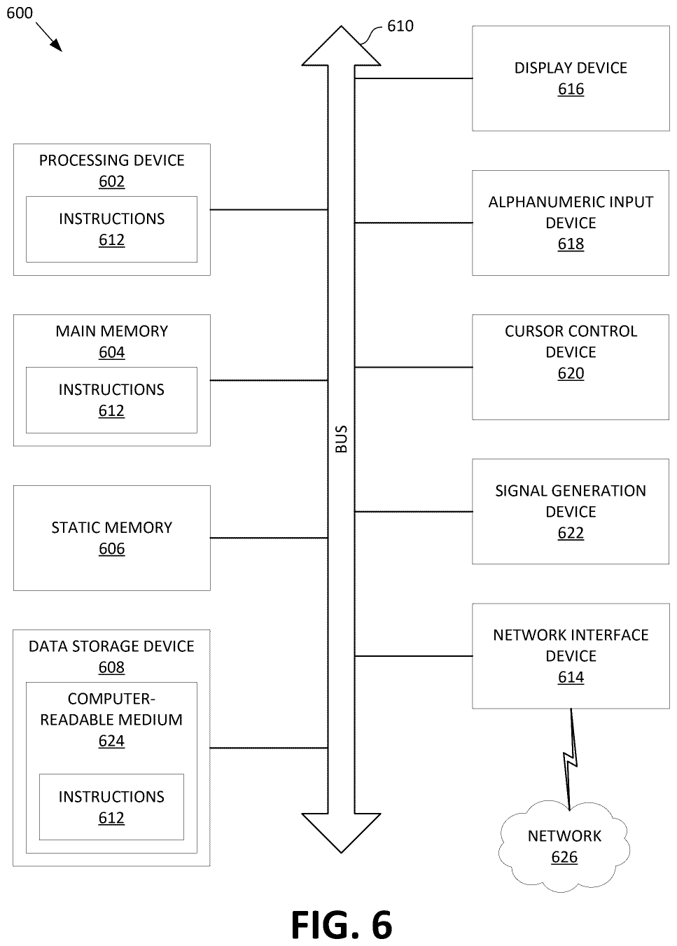

Each of servers 120-130 can be a personal computer (PC), a laptop computer, a notebook computer, a mobile phone, a smartphone, a tablet computer, a digital assistant, a rackmount server, a router computer, or similar computing device. An example computing device is further described below with reference to FIG. 6. Servers 120-130 can also be a virtualized resource such as a virtual machine (VM) or a containerized application. Servers 120-130 can also correspond to a collection of physical or virtual computing resources, such as a datacenter or a collection of servers or VMs distributed across multiple data centers. For example, servers 120-130 can correspond to cloud computing resources provisioned from a cloud computing provider. Servers 120-130 can run an operating system or one or more software applications. In an embodiment, the functions described with reference to servers 120-130 can be performed by a single server or additional servers.

Phone number database 140 can correspond to an application for receiving, storing, and providing phone number data. The term “phone number database” as used herein refers to any datastore. In particular, phone number database 140 can be a relational or non-relational database, a structured or unstructured database, a key-value store, a filesystem, or can conform to other database classifications. Phone number database 140 can be backed by various persistent or non-persistent storage devices, such as RAM, magnetic tapes or drives, solid-state drives, optical drives, or similar (e.g., other storage technologies discussed below with reference to FIG. 6). Phone number database 140 can also include storage devices in a networked topology, such as a Storage Area Network (SAN), Network-Attached Storage (NAS), cloud-provisioned storage, or similar. Phone number database 140 can be provided by a respective server or servers (not depicted). In an embodiment, phone number database 140 is provided by servers 120 and/or 130. Phone number database 140 or its respective hardware can be centralized or decentralized. Examples of database applications that can correspond to phone number database 140 include MongoDB, MySQL, MariaDB, DynamoDB, PostgreSQL, and others. Phone number database 140 can partition data into various stores, buckets, tables, etc.

Phone number database 140 can be used to store data and metadata for phone numbers of a telecommunications provider. For example, telecommunications providers can own numbers in multiple countries and/or localities. Phone number database 140 can store the country codes, prefixes, and numbers of these telephone numbers, as well as other data such as phone number capabilities (e.g., call, SMS, MMS, etc.), phone number allocations (e.g., sold to a customer, allocated to an internal service of the telecommunications provider, etc.) and similar.

Server 130 includes phone number database service 132. Phone number database service 132 can be a hardware (e.g., circuitry, dedicated logic, etc.) or software (e.g., code, libraries, firmware, etc.) tool that generates and/or executes search queries in phone number database 140 and receives and/or processes search results from phone number database 140. For example, phone number database service 132 can generate a phone number database query using latitude/longitude/radius values, area or country codes, cities, metadata, and other types of filters and search parameters. Phone number database service 132 can then receive a set of phone number search results matching the query. In an embodiment, phone number database service can generate multiple phone number database queries and receive multiple corresponding sets of search results.

Server 120 includes geographical map service 122. Geographical map service 122 can be a hardware (e.g., circuitry, dedicated logic, etc.) or software (e.g., code, libraries, firmware, etc.) tool that provides geographical map services to users (e.g., individuals or entities/organizations) or other services/applications. For example, geographical map service 122 can provide a graphical user interface (GUI) including a geographical map to a client device. Geographical map service 122 can further receive user interaction related to the geographical map, communicate with phone number database service 132 to generate phone number search queries and receive search results, and present search results on the geographical map. Geographical map service 122 can receive additional user interaction related to the displayed search results and retrieve and display phone number metadata based on the user interaction.

Client devices 150A-n can be personal computers (PCs), laptops, notebook computers, mobile phones, smartphones, tablet computers, digital assistants, network-connected televisions (e.g., smart TVs), or any other computing devices. The computer system of FIG. 6 can be an example of a client device. In various embodiments, client devices 150A-n can also be referred to as “user devices.” Client devices 150A-n can run an operating system (OS) that manages hardware and software of the client devices. Client devices 150A-n can further include a web browser, application, or other software for displaying geographical maps and interacting with servers 120-130. Client devices 150A-n can be used by users such as telecommunications provider employees and customers. In general, and as described below, functions described in embodiments as being performed by a telecommunications provider and/or server devices 120-130 can also or alternatively be performed on client devices 150A-n in other embodiments. In addition, the functionality attributed to a particular component can be performed by different or multiple components operating together.

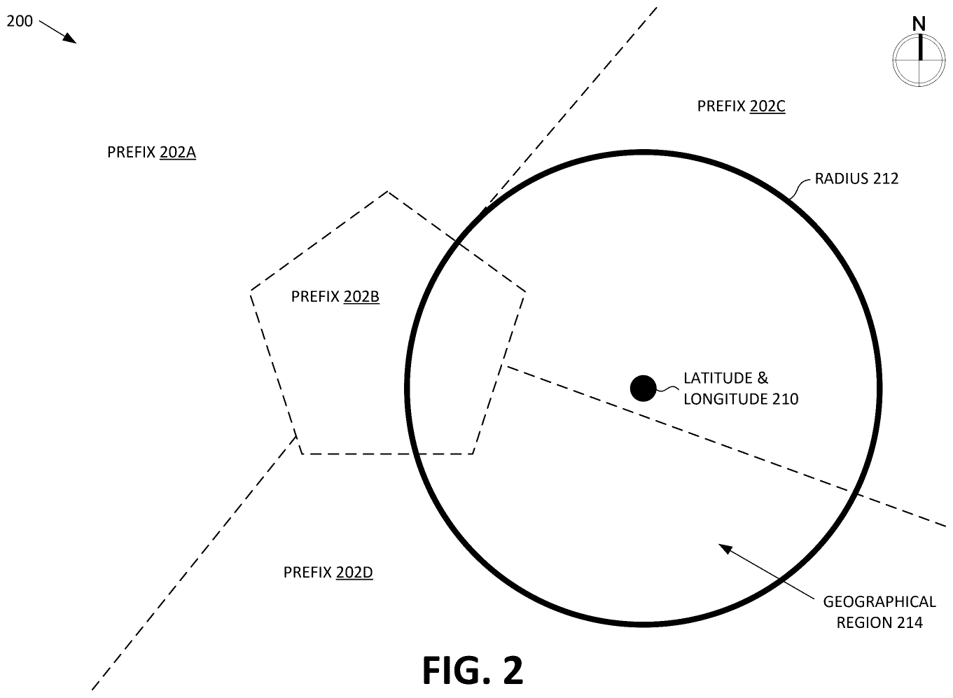

Client device 150A includes GUI 152 for presenting geographical map 200 to a user. GUI 152 and/or geographical map 200 can be received from geographical map service 122. Geographical map 200 is further described with reference to FIGS. 2-4B. GUI 152 can further receive user interaction with geographical map 200 and communicate the user interaction to geographical map service 122. Various user interactions are further described with reference to FIGS. 2-4B.

FIG. 2 illustrates an example geographical map 200 of a GUI provided to a client device by a geographical map service, in accordance with an embodiment. Geographical map 200 includes a plurality of geographical features. For example, geographical map 200 can include regions corresponding to phone number country codes or prefixes, such as prefix regions 102A-D. Geographical map 200 can include other geographical features not depicted, such as city and state locations/boundaries, highways, topographical features, and similar.

In an example interaction with geographical map 200, a user can indicate latitude and longitude 210 and search radius 212 centered on latitude and longitude 210. For example, the user can tap or click on geographical map 200 at a first location to indicate latitude and longitude 210 and tap or click on geographical map 200 at a second location to indicate radius 212. In another example, the user can tap/click at a first location to indicate latitude and longitude 210 and drag and release to indicate radius 212. In another example, the user can select a radius value from a menu and tap/click to indicate latitude and longitude 210.

Latitude and longitude 210 and radius 212 together can indicate geographical region 214 in which to search for available phone numbers. Geographical region 214 can encompass or overlap with various geographical features such as cities, prefix regions, etc. of geographical map 200. As illustrated in FIG. 2, geographical region 214 overlaps with prefix regions 202B-D.

In an embodiment, the geographical region in which to search for available phone numbers can be indicated with other types of user interactions. For example, a user can tap/click, drag, and release to indicate to corners of a rectangular geographical region. In another example, a user can tap/click within a prefix region or similar geographical feature to select that geographical feature as the search region.

In an embodiment, additional user interactions can indicate filters or additional search criteria. For example, a user can select a country code filter, a phone number capability filter, or similar.

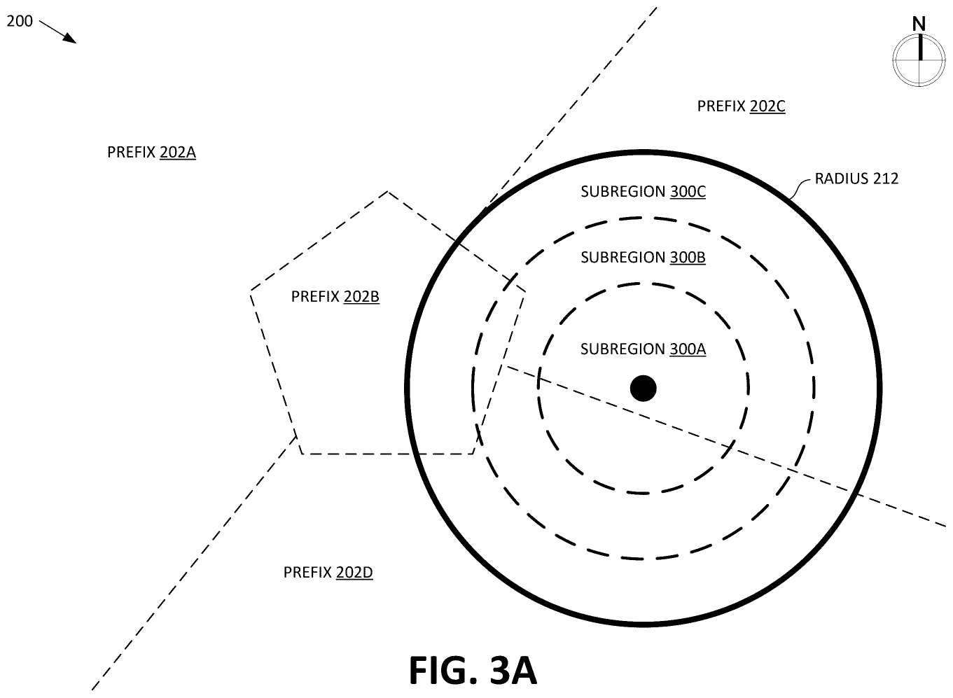

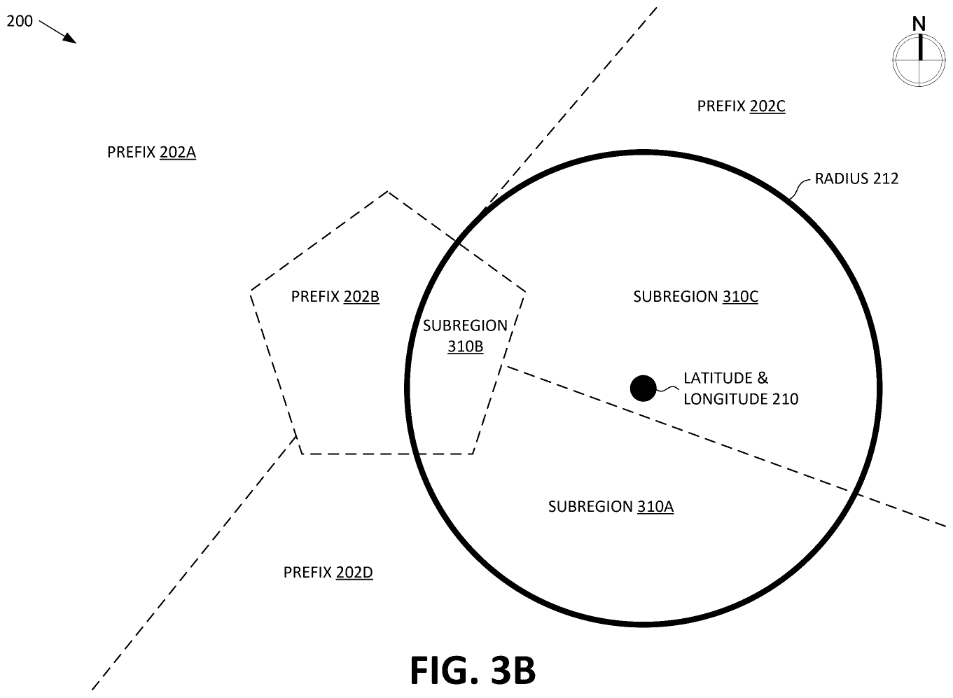

As described with reference to FIG. 1, geographical search region 214 can be provided to a geographical map service and/or a phone number database service to generate phone number database queries based on the indicated region. Example techniques for generating search queries are further described with reference to FIGS. 3A-B.

FIG. 3A illustrates an example geographical map 200 of a GUI with a geographical search region divided into multiple subregions, in accordance with an embodiment. As described with reference to FIG. 2, radius 212 can be an outer boundary of geographical search region 214 indicated by the user, and the system can generate a search query based on the indicated region.

In various embodiments, it can be beneficial to divide a single phone number search query into multiple queries. For example, a single query can potentially return a large set of search results, which can result in longer query times and longer result processing times. Dividing a single large query into multiple smaller queries can improve response time and allow results to be loaded incrementally, which can improve the user experience. In another example, a phone number database can impose a limit to the number of search results returned for a single query, so a large query matching more phone numbers than the limit can potentially return incomplete results. Thus, dividing the single large query into multiple smaller queries can ensure completeness of the returned search results, where each set of search results has fewer phone numbers than the limit.

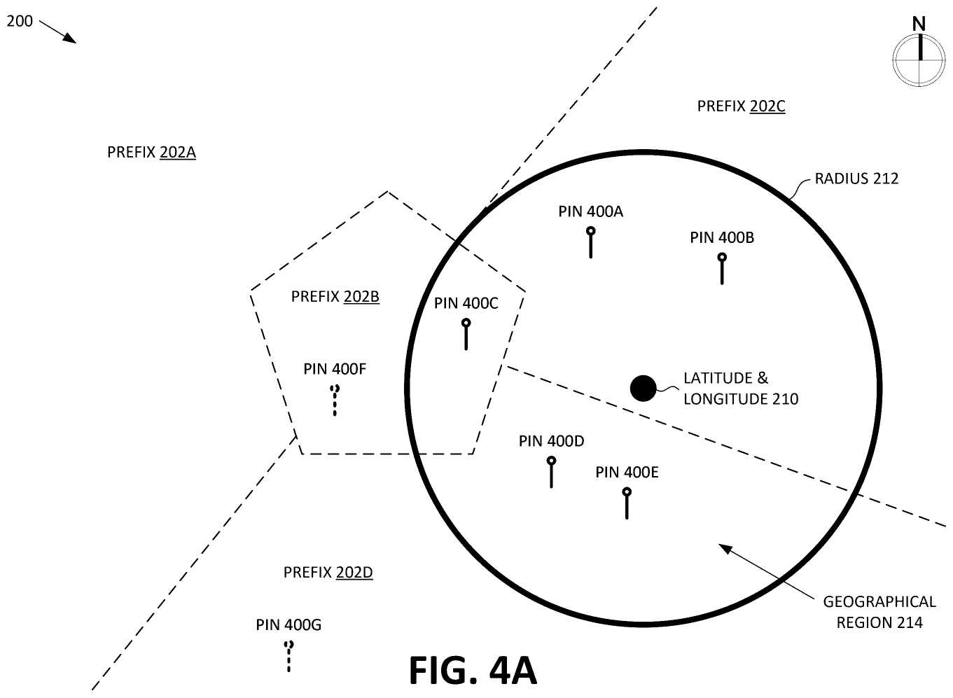

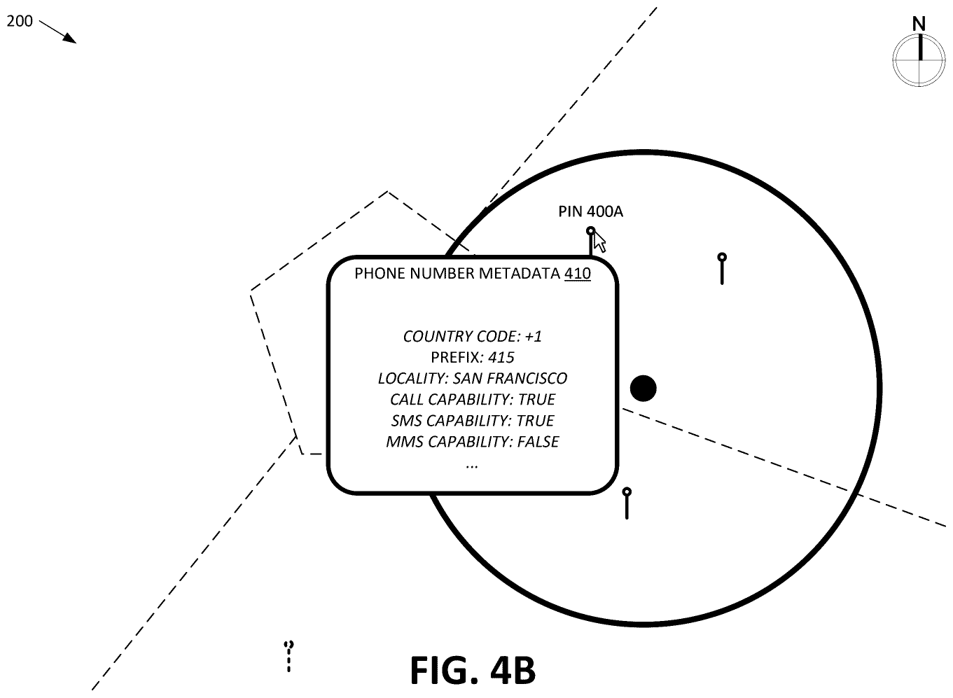

In FIG. 3A, the indicated region demarcated by radius 212 is divided into multiple concentric subregions 300A-C, which can each correspond to a respective search query. Search queries for subregions 300A-C can be performed in parallel or can be performed in sequence from 300A to 300C, from 300C to 300A, or similar. Search query results can similarly be presented in the respective subregions in parallel or in sequence as the results are received from the phone number database. Presenting search query results is further described with reference to FIGS. 4A-B.

FIG. 3B illustrates an example geographical map 200 of a GUI with a geographical search region divided into multiple subregions, in accordance with an embodiment. As described with reference to FIG. 3A, subdividing geographic search regions and respective search queries can provide various benefits. In an embodiment, the indicated region demarcated by radius 212 is divided into multiple subregions 310A-C based on geographical features such as prefix regions or similar. In FIG. 3B, subregion 310A corresponds to prefix region 202D, subregion 310B corresponds to prefix region 202B, and subregion 310C corresponds to prefix region 202C.

FIG. 4A illustrates an example geographical map 200 of a GUI with phone number search results presented on the geographical map, in accordance with an embodiment. Pins 400A-E are phone number GUI elements overlaid on geographical map 200 and are each associated with a phone number search result in geographical region 214. In an embodiment, pins 400A-E are each located at a respective latitude and longitude of a city, locality, or other geographic feature. In an embodiment, pins 400A-E are not associated with respective latitudes and longitudes and are distributed within geographical region 214 randomly or using another distribution technique.

In an embodiment, one or more search results and corresponding phone number GUI elements can be located outside of geographical region 214. For example, geographical region 214 can be used to identify intersecting prefix regions (e.g., prefix regions 202B-D), which can subsequently be used to generate the search query or queries. Thus, the search results can include phone numbers that are located in the prefix regions but outside of geographical region 214 (e.g., pins 400F-G). These results may or may not be presented on geographical map 200 in various embodiments. A user-supplied filter can also be used to determine whether to present pins 400F-G.

FIG. 4B illustrates example geographical map 200 of a GUI with phone number metadata presented on the geographical map, in accordance with an embodiment. A user can select a phone number with an additional user interaction (e.g., represented by the cursor clicking on pin 400A), and the system can subsequently present phone number metadata associated with the selected phone number. As illustrated in FIG. 4B, phone number metadata 410 is presented in a floating window attached to pin 400A. In various embodiments, phone number metadata 410 can be presented elsewhere on map 200 or external to map 200. Phone number metadata 410 illustrates example phone number metadata including country code, prefix, locality, call capability, SMS capability, and MMS capability. In various embodiments, more, fewer, or different metadata associated with a phone number can be presented.

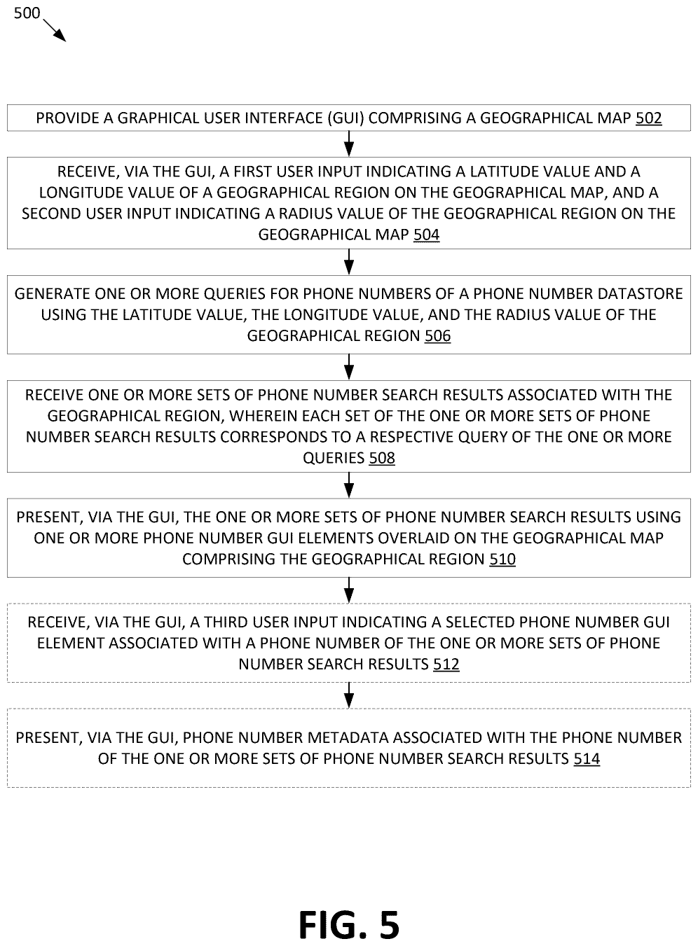

FIG. 5 is a flow diagram of an example method 500 for identification and presentation of phone numbers with geographical context, in accordance with an embodiment. Method 500 may be performed by processing logic that may comprise hardware (e.g., circuitry, dedicated logic, etc.), computer-readable instructions such as software or firmware (e.g., run on a general-purpose computing system or a dedicated machine), or a combination thereof. For instance, an example system may include a memory and a processing device coupled to the memory device to perform operations comprising the blocks of method 500. Method 500 may also be associated with a set of instructions stored on a non-transitory computer-readable medium (e.g., magnetic or optical disk, etc.). The instructions, when executed by a processing device, may cause the processing device to perform operations comprising the blocks of method 500. In an embodiment, method 500 is performed by server 120, geographical map service 122, server 130, and/or phone number database service 132 of FIG. 1. In an embodiment, method 500 is performed by computing system 600 of FIG. 6. In some embodiments, blocks depicted in FIG. 5 could be performed simultaneously or in a different order than depicted. Various embodiments may include additional blocks not depicted in FIG. 5 or a subset of blocks depicted in FIG. 5. For example, blocks depicted with dashed outlines (e.g., blocks 512-514) can be omitted in various embodiments.

At block 502, processing logic provides a graphical user interface (GUI) comprising a geographical map. The GUI can be GUI 152 of FIG. 1 and can be provided to one of client devices 150A-n (e.g., by geographical map service 122).

At block 504, the processing logic receives, via the GUI, a first user input indicating a latitude value and a longitude value of a geographical region on the geographical map, and a second user input indicating a radius value of the geographical region on the geographical map. The latitude value and longitude value can correspond to latitude and longitude 210 of FIG. 2. The radius value can correspond to radius 212 of FIG. 2. The geographical region can be the region centered at the latitude and longitude value and extending to the radius value (e.g., geographical region 214). In an embodiment, the geographical region can be a state, city outline, county outline, etc. and can be selected with a single user interaction.

At block 506, the processing logic generates one or more queries for phone numbers of a phone number datastore (e.g., phone number database) using the latitude value, the longitude value, and the radius value of the geographical region. The phone number datastore can be phone number database 140 of FIG. 1. The queries can be provided to phone number database service 132 of server 130, which can run the queries using phone number database 140.

In an embodiment, generating the one or more queries for the phone numbers of the phone number datastore comprises identifying a plurality of subregions of the geographical region and generating a plurality of queries each comprising an indication of a respective subregion of the plurality of subregions. In an embodiment, the plurality of subregions comprises concentric subregions each associated with a respective radius value less than or equal to the radius value of the geographical region. In an embodiment, the plurality of subregions comprises subregions each associated with a respective prefix of a plurality of prefixes.

In an embodiment, generating the one or more queries for the phone numbers of the phone number datastore comprises identifying one or more prefixes associated with the geographical region using a mapping of geographical regions to prefixes and generating a respective query for each prefix of the one or more prefixes.

In an embodiment, the one or more queries are further associated with a filter value for a phone number characteristic. Prior to generating the one or more queries at block 506, method 500 can further comprise receiving, via the GUI, an additional user input indicating the filter value for the phone number characteristic, wherein the phone number characteristic is one of: a phone number locality (e.g., city), a phone number region (e.g., state and/or county), a phone number prefix, or a phone number capability.

At block 508, the processing logic receives one or more sets of phone number search results associated with the geographical region, wherein each set of the one or more sets of phone number search results corresponds to a respective query of the one or more database queries. The search results can be received from server 130, phone number database service 132, and/or phone number database 140.

At block 510, the processing logic presents, via the GUI, the one or more sets of phone number search results using one or more phone number GUI elements overlaid on the geographical map comprising the geographical region. The one or more phone number GUI elements can correspond to pins 400A-E or pins 400A-G of FIG. 4A.

At block 512, the processing logic receives, via the GUI, a third user input indicating a selected phone number GUI element associated with a phone number of the one or more sets of phone number search results. For example, the user can tap or click on one of pins 400A-E.

At block 514, the processing logic presents, via the GUI, phone number metadata associated with the phone number of the one or more sets of phone number search results. The phone number metadata can correspond to phone number metadata 410 of FIG. 4B.

FIG. 6 is a block diagram illustrating an example computer system 600, in accordance with implementations of the present disclosure. Computer system 600 may correspond to servers 120 or 130 or client devices 150A-n, as described above with reference to FIG. 1. Computer system 600 may operate in the capacity of a server or an endpoint machine in endpoint-server network environment, or as a peer machine in a peer-to-peer (or distributed) network environment. The machine may be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Computer system 600 includes processing device 602 (e.g., one or more processors or cores), main memory 604 (e.g., read-only memory (ROM), flash memory, dynamic random access memory (DRAM) such as synchronous DRAM (SDRAM), double data rate (DDR SDRAM), or DRAM (RDRAM), etc.), static memory 606 (e.g., flash memory, static random access memory (SRAM), etc.), and data storage device 608, which communicate with each other via bus 610.

Processing device 602 represents one or more general-purpose processing devices such as a microprocessor, central processing unit, or the like. More particularly, processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute instructions 612 (e.g., for storing contextual data with context schemas) for performing the operations discussed herein.

Computer system 600 may further include network interface device 614. Computer system 600 also may include display device 616 (e.g., a liquid crystal display (LCD) or a cathode ray tube (CRT)), alphanumeric input device 618 (e.g., a keyboard, and alphanumeric keyboard, a motion sensing input device, touch screen), cursor control device 620 (e.g., a mouse), and signal generation device 622 (e.g., a speaker). In some embodiments, computer system 600 may not include display device 616, alphanumeric input device 618, and/or cursor control device 620 (e.g., in a headless configuration).

Data storage device 608 may include a non-transitory machine-readable storage medium 624 (also computer-readable storage medium) on which is stored one or more sets of instructions 612 (e.g., for storing contextual data with context schemas) embodying any one or more of the methodologies or functions described herein. Instructions 612 may also reside, completely or at least partially, within main memory 604 or within the processing device 602 during execution thereof by computer system 600, main memory 604 and processing device 602 also constituting machine-readable storage media. Instructions 612 may further be transmitted or received over network 626 via network interface device 614.

In one implementation, instructions 612 include instructions for storing contextual data with context schemas, as described herein. While computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above-described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A method comprising:
providing a graphical user interface (GUI) comprising a geographical map;
receiving, via the GUI, a first user input indicating a latitude value and a longitude value of a geographical region on the geographical map, and a second user input indicating a radius value of the geographical region on the geographical map;
generating one or more queries for phone numbers of a phone number datastore using the latitude value, the longitude value, and the radius value of the geographical region;
receiving one or more sets of phone number search results associated with the geographical region, wherein each set of the one or more sets of phone number search results corresponds to a respective query of the one or more queries; and
presenting, via the GUI, the one or more sets of phone number search results using one or more phone number GUI elements overlaid on the geographical map comprising the geographical region.

2. The method of claim 1, wherein generating the one or more queries for the phone numbers of the phone number datastore comprises:
identifying a plurality of subregions of the geographical region; and
generating a plurality of queries each comprising an indication of a respective subregion of the plurality of subregions.

3. The method of claim 2, wherein the plurality of subregions comprises concentric subregions each associated with a respective radius value less than or equal to the radius value of the geographical region.

4. The method of claim 2, wherein the plurality of subregions comprises subregions each associated with a respective prefix of a plurality of prefixes.

5. The method of claim 1, wherein generating the one or more queries for the phone numbers of the phone number datastore comprises:
identifying one or more prefixes associated with the geographical region using a mapping of geographical regions to prefixes; and
generating a respective query for each prefix of the one or more prefixes.

6. The method of claim 1, wherein the one or more queries are further associated with a filter value for a phone number characteristic, and wherein the method further comprises:
prior to generating the one or more queries, receiving, via the GUI, a third user input indicating the filter value for the phone number characteristic, wherein the phone number characteristic is one of: a phone number locality, a phone number region, a phone number prefix, or a phone number capability.

7. The method of claim 1, further comprising:
receiving, via the GUI, a third user input indicating a selected phone number GUI element associated with a phone number of the one or more sets of phone number search results; and
presenting, via the GUI, phone number metadata associated with the phone number of the one or more sets of phone number search results.

8. A system comprising:
a memory device; and
a processing device coupled to the memory device, the processing device to perform operations comprising:
providing a graphical user interface (GUI) comprising a geographical map;
receiving, via the GUI, a first user input indicating a latitude value and a longitude value of a geographical region on the geographical map, and a second user input indicating a radius value of the geographical region on the geographical map;
generating one or more queries for phone numbers of a phone number datastore using the latitude value, the longitude value, and the radius value of the geographical region;
receiving one or more sets of phone number search results associated with the geographical region, wherein each set of the one or more sets of phone number search results corresponds to a respective query of the one or more queries; and
presenting, via the GUI, the one or more sets of phone number search results using one or more phone number GUI elements overlaid on the geographical map comprising the geographical region.

9. The system of claim 8, wherein generating the one or more queries for the phone numbers of the phone number datastore comprises:
identifying a plurality of subregions of the geographical region; and
generating a plurality of queries each comprising an indication of a respective subregion of the plurality of subregions.

10. The system of claim 9, wherein the plurality of subregions comprises concentric subregions each associated with a respective radius value less than or equal to the radius value of the geographical region.

11. The system of claim 9, wherein the plurality of subregions comprises subregions each associated with a respective prefix of a plurality of prefixes.

12. The system of claim 8, wherein generating the one or more queries for the phone numbers of the phone number datastore comprises:
identifying one or more prefixes associated with the geographical region using a mapping of geographical regions to prefixes; and
generating a respective query for each prefix of the one or more prefixes.

13. The system of claim 8, wherein the one or more queries are further associated with a filter value for a phone number characteristic, and wherein the operations further comprise:
prior to generating the one or more queries, receiving, via the GUI, a third user input indicating the filter value for the phone number characteristic, wherein the phone number characteristic is one of: a phone number locality, a phone number region, a phone number prefix, or a phone number capability.

14. The system of claim 8, the operations further comprising:
receiving, via the GUI, a third user input indicating a selected phone number GUI element associated with a phone number of the one or more sets of phone number search results; and
presenting, via the GUI, phone number metadata associated with the phone number of the one or more sets of phone number search results.

15. A non-transitory computer-readable medium comprising instructions that, when executed by a processing device, cause the processing device to perform operations comprising:
providing a graphical user interface (GUI) comprising a geographical map;
receiving, via the GUI, a first user input indicating a latitude value and a longitude value of a geographical region on the geographical map, and a second user input indicating a radius value of the geographical region on the geographical map;
generating one or more queries for phone numbers of a phone number datastore using the latitude value, the longitude value, and the radius value of the geographical region;
receiving one or more sets of phone number search results associated with the geographical region, wherein each set of the one or more sets of phone number search results corresponds to a respective query of the one or more queries; and
presenting, via the GUI, the one or more sets of phone number search results using one or more phone number GUI elements overlaid on the geographical map comprising the geographical region.

16. The non-transitory computer-readable medium of claim 15, wherein generating the one or more queries for the phone numbers of the phone number datastore comprises:
identifying a plurality of subregions of the geographical region; and
generating a plurality of queries each comprising an indication of a respective subregion of the plurality of subregions.

17. The non-transitory computer-readable medium of claim 16, wherein the plurality of subregions comprises concentric subregions each associated with a respective radius value less than or equal to the radius value of the geographical region.

18. The non-transitory computer-readable medium of claim 16, wherein the plurality of subregions comprises subregions each associated with a respective prefix of a plurality of prefixes.

19. The non-transitory computer-readable medium of claim 15, wherein generating the one or more queries for the phone numbers of the phone number datastore comprises:
identifying one or more prefixes associated with the geographical region using a mapping of geographical regions to prefixes; and
generating a respective query for each prefix of the one or more prefixes.

20. The non-transitory computer-readable medium of claim 15, wherein the one or more queries are further associated with a filter value for a phone number characteristic, and wherein the operations further comprise:
prior to generating the one or more queries, receiving, via the GUI, a third user input indicating the filter value for the phone number characteristic, wherein the phone number characteristic is one of: a phone number locality, a phone number region, a phone number prefix, or a phone number capability.
